(19) United States
(12) Patent Application Publication
(10) Pub. No.: US 2026/0320418 A1
(43) Pub. Date: Oct. 15, 2026

(54) ARTIFICIAL INTELLIGENCE (AI) FOR DEVICE LIFE CYCLE PREDICTION

(71) Applicant: Schneider Electric Industries SAS, Rueil-Malmaison (FR)

(72) Inventors: Augustin Jean Cathignol, Grenoble (FR); Jacques Michel Kluska, Grenoble (FR)

(73) Assignee: Schneider Electric Industries SAS, Rueil-Malmaison (FR)

(21) Appl. No.: 19/176,909

(22) Filed: Apr. 11, 2025

(51) Int. Cl. G06N 5/022

(52) U.S. Cl. CPC G06N 5/022

(57) ABSTRACT

Techniques for AI for device life cycle prediction are described. For instance, an apparatus receives sensor data representing one or more present operational conditions of a device and inputs the sensor data to an artificial intelligence (AI) model trained using a known data set associated with one or more known operational conditions of the device. The apparatus adapts operation of the AI model based at least in part on the sensor data and generates a life cycle prediction for the device based at least in part on output from the AI model. The life cycle prediction, for example, can include an estimated number of remaining operations of the device before device failure may occur.

### BACKGROUND

Devices (e.g., electrical devices, mechanical devices, computational devices, etc.) play an integral role in various processes. Device failures may occur, however, which may cause disruptions in critical processes. For example, device failures may result in reduced productivity, data loss, safety risks, etc. Thus, maintaining devices in an operational state represents a crucial consideration.

### SUMMARY

In some aspects, the techniques described herein relate to an apparatus, including: at least one memory; and at least one processor coupled with the at least one memory and operable to cause the apparatus to: receive sensor data representing one or more present operational conditions of a device; input the sensor data to an artificial intelligence (AI) model trained using a known data set associated with one or more known operational conditions of the device; adapt operation of the AI model based at least in part on the sensor data; and generate a life cycle prediction for the device based at least in part on output from the AI model. In some implementations, the life cycle prediction includes an estimated number of remaining lifetime (e.g., number of operations) of the device.

In some aspects, the techniques described herein relate to an apparatus, wherein the sensor data includes one or more of motion data, power data, contact distance data, temperature data, or image data.

In some aspects, the techniques described herein relate to an apparatus, wherein the AI model is trained using the known data set prior to input of the sensor data to the AI model.

In some aspects, the techniques described herein relate to an apparatus, wherein the operation of the AI model is adapted via modification of a hyperparameter associated with the AI model based at least in part on the known data set and the sensor data.

In some aspects, the techniques described herein relate to an apparatus, wherein modification of the hyperparameter includes adjusting a ratio of the sensor data relative to the known data set.

In some aspects, the techniques described herein relate to an apparatus, wherein adjusting the ratio of the sensor data relative to the known data set includes one of: increasing a weight value for the sensor data and decreasing a weight value for the known data set; or decreasing a weight value for the sensor data and increasing a weight value for the known data set.

In some aspects, the techniques described herein relate to an apparatus, wherein adjusting the ratio of the sensor data relative to the known data set is based at least in part on one or more of a time period over which the sensor data is received, or an amount of the sensor data that is received.

In some aspects, the techniques described herein relate to an apparatus, wherein the life cycle prediction is based at least in part on a comparison of the output from the AI model to one or more life cycle thresholds.

In some aspects, the techniques described herein relate to an apparatus, wherein the at least one processor is operable to cause the apparatus to: output an indication of the life cycle prediction, wherein the indication of the life cycle prediction includes an indication of a duration over which the device is estimated to be operable within one or more threshold operation parameters.

In some aspects, the techniques described herein relate to an apparatus, wherein the indication of the duration includes one or more of a time duration or a number of operations of the device.

In some aspects, the techniques described herein relate to an apparatus, wherein the indication of the duration includes a first indication of a duration of an operational lifetime of the device, and a second indication of an operational extension of the duration of the operational lifetime of the device.

In some aspects, the techniques described herein relate to an apparatus, wherein the at least one processor is operable to cause the apparatus to: receive an indication of user input associated with operational conditions of the device; and process the sensor data based at least in part on the user input.

In some aspects, the techniques described herein relate to an apparatus, wherein the at least one processor is operable to cause the apparatus to: receive an indication of user input associated with operation of the AI model; and further adapt operation of the AI model based at least in part on the user input.

In some aspects, the techniques described herein relate to an apparatus, wherein the user input includes a modification of a hyperparameter associated with the AI model.

In some aspects, the techniques described herein relate to an apparatus, wherein the device includes a circuit breaker, and wherein the life cycle prediction includes one or more of an estimated number of remaining operations of the circuit breaker or an estimated remaining operation lifetime of the circuit breaker. The estimated number of remaining operations and/or estimated remaining operational lifetime may represent and an estimated number of remaining operations and/or duration of time until the circuit breaker is predicted to fail.

In some aspects, the techniques described herein relate to an apparatus, wherein the sensor data and the one or more known operational conditions of the circuit breaker are associated with an erosion gap for a set of contacts of the circuit breaker.

In some aspects, the techniques described herein relate to a method performed by an apparatus, the method including: receiving sensor data representing one or more present operational conditions of a device; inputting the sensor data to an artificial intelligence (AI) model trained using a known data set associated with one or more known operational conditions of the device; adapting operation of the AI model based at least in part on the sensor data; and generating a life cycle prediction for the device based at least in part on output from the AI model.

In some aspects, the techniques described herein relate to a method, wherein adapting operation of the AI model includes modifying a hyperparameter associated with the AI model based at least in part on the sensor data.

In some aspects, the techniques described herein relate to a method, wherein modifying the hyperparameter includes adjusting a ratio of the sensor data relative to the known data set.

In some aspects, the techniques described herein relate to a method, wherein adjusting the ratio of the sensor data relative to the known data set includes one of: increasing a weight value for the sensor data and decreasing a weight value for the known data set; or decreasing a weight value for the sensor data and increasing a weight value for the known data set.

In some aspects, the techniques described herein relate to a method, further including: outputting an indication of the life cycle prediction, wherein the indication of the life cycle prediction includes an indication of a duration over which the device is estimated to be operable within one or more threshold operation parameters.

In some aspects, the techniques described herein relate to a system, including: a sensor interface operable to receive sensor data representing one or more present operational conditions of a device; and a state monitor operable to: input the sensor data to an artificial intelligence (AI) model trained using a known data set associated with one or more known operational conditions of the device; adapt operation of the AI model based at least in part on the sensor data; and generate a life cycle prediction for the device based at least in part on output from the AI model.

### BRIEF DESCRIPTION OF THE DRAWINGS

Aspects of AI for device life cycle prediction are described with reference to the following Figures. The same numbers may be used throughout to reference similar features and components that are shown in the Figures. Further, identical numbers followed by different letters reference different instances of features and components described herein:

FIG. 1 illustrates an example environment in which aspects of AI for device life cycle prediction can be implemented.

FIG. 2 illustrates a system for AI for device life cycle prediction in accordance with aspects of the present disclosure.

FIG. 3 illustrates a system for AI for device life cycle prediction in accordance with aspects of the present disclosure.

FIG. 4 illustrates an example system in accordance with aspects of the present disclosure.

FIG. 5 illustrates an example GUI in accordance with aspects of the present disclosure.

FIG. 6 illustrates a system for AI for device life cycle prediction in accordance with aspects of the present disclosure.

FIG. 7 illustrates a flow chart depicting an example method for AI for device life cycle prediction in accordance with one or more implementations.

FIG. 8 illustrates a flow chart depicting an example method for AI for device life cycle prediction in accordance with one or more implementations.

FIG. 9 illustrates a flow chart depicting an example method for AI for device life cycle prediction in accordance with one or more implementations.

FIG. 10 illustrates various components of an example apparatus in which aspects of AI for device life cycle prediction can be implemented.

### DETAILED DESCRIPTION

Techniques for AI for device life cycle prediction are described. As discussed herein, AI may refer to AI techniques, machine learning (ML) techniques, and combinations thereof (e.g., AI/ML). For instance, the described techniques can be implemented to utilize AI to monitor state conditions of devices and to predict different life cycle conditions of the devices.

In some implementations, a device (e.g., an electrical device, a mechanical device, a computational device, and/or combinations thereof) may be configured with sensors that are operable to detect different operational attributes of the device, such as motion, temperature, power attributes (e.g., electrical current, voltage), image data, etc. An apparatus (e.g., a computing device) can be communicatively connected to the sensors and receive sensor data from the sensors. The apparatus can employ an AI model to utilize the sensor data to detect state conditions of the device, and to perform life cycle predictions for the device. A device life cycle prediction, for example, can include an estimated number of remaining operations and/or a remaining operational lifetime of the device before device failure occurs. In implementations, an AI model represents programs and/or algorithms trained on a set of data to provide outputs, such as to recognize patterns, make decisions, generate content, etc. AI models, for instance, can apply different algorithms to data inputs to provide data output for performing different tasks.

In some implementations, an AI model can be trained using a known data set associated with one or more known operational conditions of the device. The known data set, for example, can be generated based on experimentally and/or empirically gathered data that indicates different operational conditions of instances of the device, expert knowledge, experimental data, device simulations, technical studies (e.g., technical literature), etc. Initial operation parameters of the AI model can thus be configured based on the known data set. The sensor data from the device can be used to further adapt operation of the AI model, such as to adapt the operation parameters (e.g., model weights of the known data and the sensor data) of the AI model. The model weights can be determined using model hyperparameters (e.g., Bayesian hyperparameters) that can be updated during model operation for device life cycle prediction. For example, model hyperparameters that are initially configured via the known data set can be further adapted via the sensor data. The hyperparameters can be implemented to dynamically determine a ratio (e.g., balance) of the known data set relative to the sensor data for determining model weights and predicting (e.g., estimating, calculating) life cycle predictions for the device. The hyperparameters, for example, can be optimized to increase accuracy of life cycle predictions. The AI model may be employed to perform different predictions regarding the device, such as current operating conditions of the device and life cycle predictions for the device. For example, the AI model may be employed to predict different life cycle stages of the device, such as to predict when the device may be in a maintenance state and or at an end of a useful life of the device. The life cycle stages may be indicated in terms of time durations and/or device operations.

In implementations, utilizing Bayesian techniques as described herein can provide for optimizing accuracy of life cycle stage prediction. For instance, the described techniques can increase prediction accuracy as compared with techniques that utilize only existing data sets, which utilize only sensor data, or that do not adapt to dynamic conditions that may affect the balance between existing data sets and sensor data.

Accordingly, techniques described herein may be employed to perform life cycle predictions for devices, which can enable various actions to be proactively performed (e.g., device maintenance, device replacement) to mitigate adverse issues that may occur due to device failure. For example, the described techniques can enable a reduction in system downtime, data loss, safety risks, etc., that may result from device failure.

While features and concepts of AI for device life cycle prediction can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

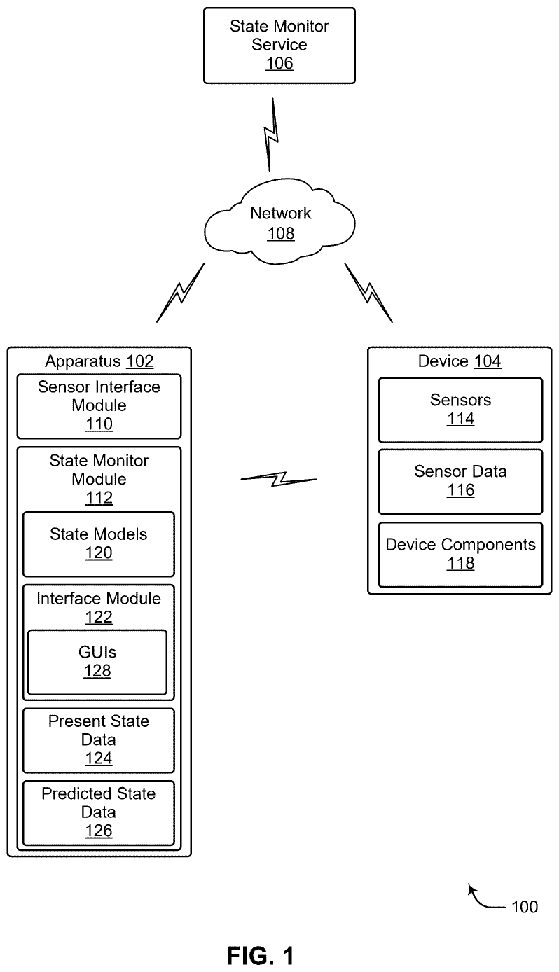

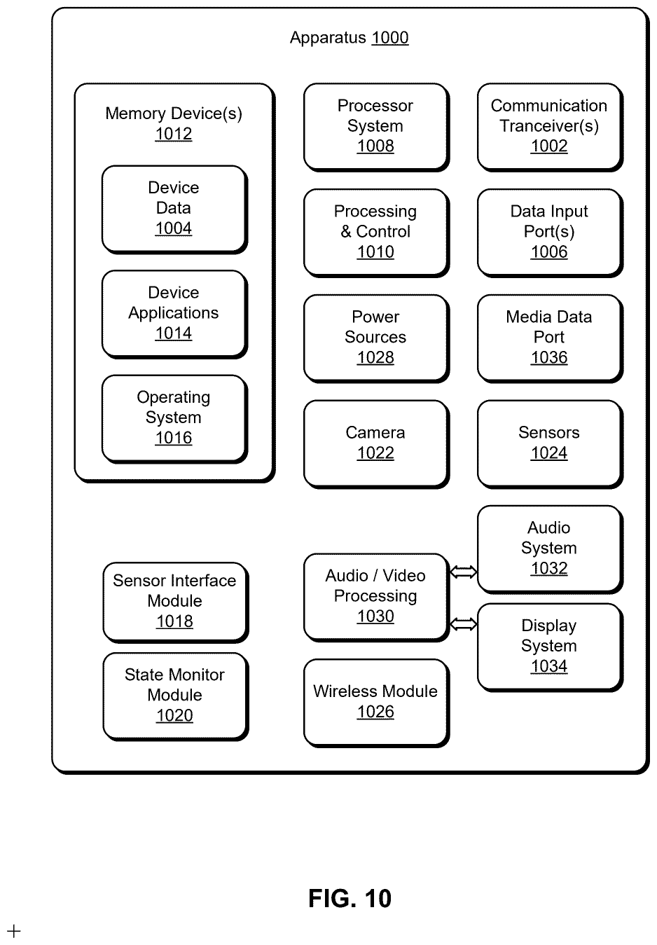

FIG. 1 illustrates an example environment 100 in which aspects of AI for device life cycle prediction can be implemented. The environment 100 includes an apparatus 102, a device 104, and a state monitor service 106, which are interconnectable in various ways. The apparatus 102, the device 104, and/or the state monitor service 106, for example, may be connected via connectivity (e.g., wireless and/or wired connectivity) to a network 108. Alternatively, or in addition, the apparatus 102, the device 104, and/or the state monitor service 106 may be directly connected, such as via direct wired and/or wireless connectivity between the apparatus 102, the device 104, and/or the state monitor service 106. The apparatus 102 may be implemented in different ways, such as a mobile device (e.g., smartphone, laptop computer, tablet computer, wearable device, etc.), a desktop computer, a dedicated workstation device, etc. Example attributes of the apparatus 102 are discussed below with reference to the apparatus 1000 of FIG. 10.

The device 104 may be implemented in various ways, such as a device or set of devices that are operable to and/or operate to perform different tasks. Examples of the device 104 include circuit breakers, electrical switches, electrical motors, power converters, power transformers, batteries, battery chargers, computational devices, etc. These examples are presented for purpose of example only, and the device 104 may be implemented in a variety of different ways. While the apparatus 102 is discussed and/or illustrated as being separate from the device 104, in at least some implementations, the apparatus 102 may be integrated into the device 104, e.g., as integrated functionality of the device 104.

The apparatus 102 may be implemented to monitor and report state information regarding the device 104, such as present (e.g., current, real-time, or near real-time) operational conditions, and predictive operational conditions of the device 104. Accordingly, the apparatus 102 includes functionality for enabling aspects of AI for device life cycle prediction described herein, including a sensor interface module 110 and a state monitor module 112. The sensor interface module 110 represents functionality to interface with sensors 114 of the device 104. The sensors 114 are representative of functionality to detect various physical and/or logical phenomena in relation to the device 104, such as motion, temperature, power (e.g., electrical current, voltage), humidity, light, image detection and recognition, time and date, position, location, sound, and so forth. Examples of the sensors 114 include hardware and/or logical sensors such as an accelerometer, a gyroscope, a contact sensor, a power sensors (e.g., a voltage sensor, a current sensor), a camera, a microphone, a clock, position sensors, environmental sensors (e.g., for temperature, pressure, humidity, and so on), geographical location information sensors (e.g., Global Positioning System (GPS) functionality), and so forth. The sensors 114, however, can include a variety of other sensor types in accordance with the implementations discussed herein.

The sensors 114 may be configured (e.g., fitted, installed, positioned) to collect and/or generate sensor data 116 that represents different state attributes of the device 104. In at least some implementations, the sensor data 116 represents state attributes of device components 118 of the device 104. The device components 118, for example, represent physical components of the device 104 that are operable to perform functionality of the device 104. Examples of the sensor data 116 include attributes of the device 104 and/or device components 118 of the device 104, such as position data, temperature data, wear data, power data (e.g., voltage, current, etc.), motion data, humidity data, sound data, etc.

The state monitor module 112 represents functionality for monitoring different state attributes of devices, including state attributes of the device 104. The state monitor module 112 includes and/or has access to state models 120 and an interface module 122. The state models 120 represent AI models that may be employed to determine (e.g., assess, predict) different states of the device 104, and different instances of the state models 120 may be generated for different instances of devices. The state models 120 may be implemented in different ways, such as regression models, neural networks, etc. Further, the described techniques may implement Bayesian techniques as part of operation of the state models 120, such as using known data sets and sensor data to predict device state data, e.g., device life cycle predictions.

In implementations, the state models 120 may be implemented to determine present state data 124 and predicted state data 126 pertaining to the device 104. The present state data 124 can represent a present operational state of the device 104, such as a state of different device components 118 of the device 104. The predicted state data 126 can represent different estimated operational states of the device 104, such as estimated operational states over a future period of time and/or a future number of device operations. In some examples, the predicted state data 126 can indicate a predicted operational lifetime of the device 104, e.g., a predicted period of time and/or number of operations until the device 104 exceeds threshold acceptable operational parameters. In some implementations, a number of operations of the device 104 can include different applicable units, such as a number of device actuations, a number of device on/off cycles, a number of device starts, etc.

In at least some implementations, the sensor interface module 110 can receive the sensor data 116 from the sensors 114, and the state monitor module 112 may utilize the sensor data 116 to control operation of the state models 120 for generating the present state data 124 and/or the predicted state data 126. For example, the sensor data 116 can be utilized to modify operational parameters (e.g., hyperparameters, weights) of the state models 120 to enable the state models 120 to adapt to changes in conditions of the device 104 and provide accurate indications of the present state data 124 and/or the predicted state data 126.

The interface module 122 represents functionality for enabling interaction (e.g., user interaction) with the state monitor module 112. For example, the interface module 122 can generate and output graphical user interfaces (GUIs) 128 that present analytics data for the device 104, such as present state data 124 and/or predicted state data 126. The GUIs 128 may also enable user interaction with the state monitor module 112 to specify and/or adjust monitoring parameters of the state monitor module 112. Further aspects and features of the interface module 122 and the GUIs 128 are discussed throughout this disclosure.

Operations and functionality of the apparatus 102 discussed herein may additionally or alternatively be implemented and/or performed by the state monitor service 106, and/or via interaction between the apparatus 102 and the state monitor service 106. For example, the state monitor service 106 may include and/or implement functionality of the sensor interface module 110 and/or the state monitor module 112. As used herein, the term “functionality” may refer to hardware, software, firmware, and/or combinations thereof.

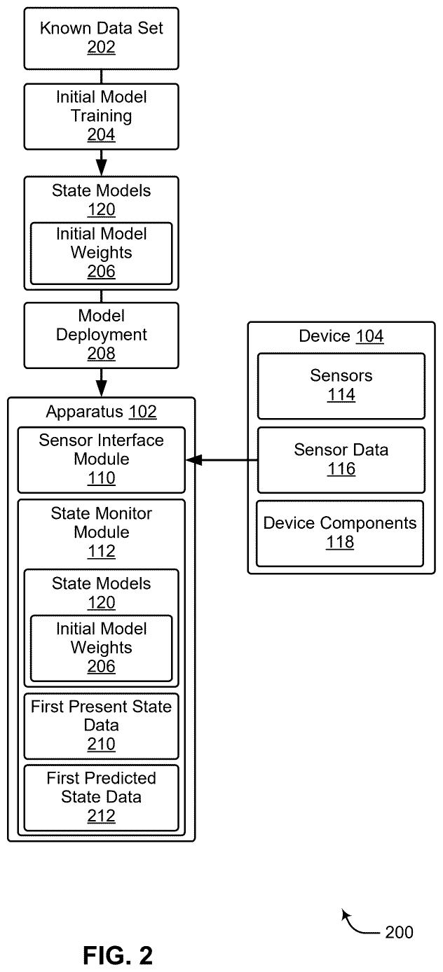

FIG. 2 illustrates a system 200 for AI for device life cycle prediction in accordance with aspects of the present disclosure. The system 200, for example, represents an initial deployment of state models 120 for determining and/or predicting state data for a device 104. In the system 200, known data 202 is utilized to perform initial model training 204 of the state models 120. The known data 202, for example, represents data that is aggregated (e.g., generated, collected) based on known operating conditions and/or attributes of instances of the device 104. For instance, the known data 202 can be collected based on observed operating conditions and/or attributes of instances of the device 104 over time, such as empirical measurements of operating conditions and/or attributes of instances of the device 104 over time. Alternatively, or in addition, the known data 202 can be received from one or more data storage repositories that store known data associated with instances of the device 104. Examples of the known data 202 include previously collected sensor data (e.g., from an instance of a device 104), simulation information, data based on expert knowledge, etc. The initial model training 204 may include configuring initial model weights 206 of the state models 120. For example, numerical values of the initial model weights 206 may be set based on the known data 202.

Further to the system 200, model deployment 208 can be performed to deploy the initially trained state models 120 for operation by the apparatus 102. In some implementations, the initial model training 204 may be performed prior to deployment of the state models 120 to the apparatus 102, and/or after deployment of the state models 120 to the apparatus 102. The sensor interface module 110 can receive sensor data 116 from the device 104, and communicate the sensor data 116 to the state monitor module 112. The state monitor module 112 can input the sensor data 116 to the state models 120, and the state models 120 can process the sensor data 116 based on the initial model weights 206 to output (e.g., generate) first present state data 210 and/or first predicted state data 212 associated with the device 104. The first present state data 210, for example, can represent a present (e.g., current, real-time, or near real-time) operational state of the device 104, such as a state of different device components 118 of the device 104. The first predicted state data 212 can represent different estimated operational states of the device 104, such as estimated operational states over a future period of time, a future number of device operations, and/or other relevant device operational unit. In some examples, the first predicted state data 212 can indicate a predicted operational lifetime of the device 104, e.g., a predicted period of time and/or number of operations until the device 104 exceeds threshold acceptable operational parameters.

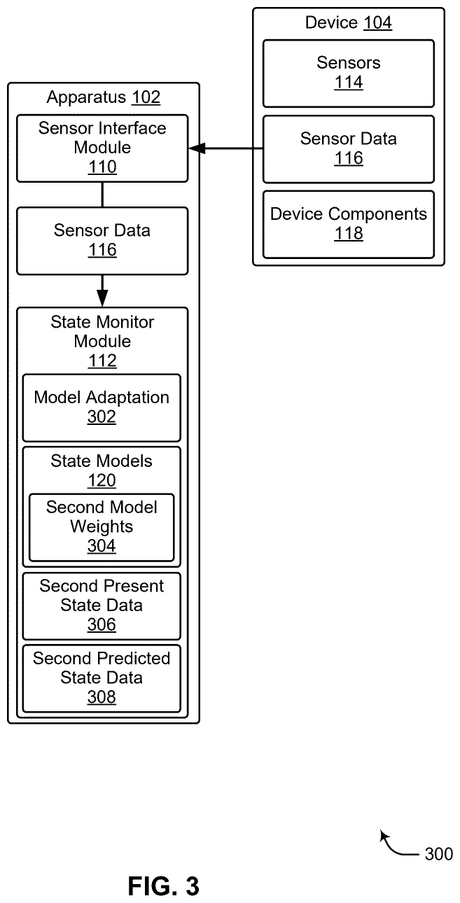

FIG. 3 illustrates a system 300 for AI for device life cycle prediction in accordance with aspects of the present disclosure. The system 300, for example, represents an extension and/or continuation of the system 200, and is discussed at least in part with reference to the system 200. In the system 300, the sensor interface module 110 receives sensor data 116 from the device 104 and communicates the sensor data 116 to the state monitor module 112. The state monitor module 112 can utilize the sensor data 116 to perform model adaptation 302 to adapt model parameters of the state models 120 based on the sensor data 116. In some implementations, the model adaptation 302 can include modifying model weights of the state models 120 based on the sensor data 116 to generate second model weights 304 for the state models 120. The second model weights 304, for example, may be generated by adjusting, for one or more weights of the state models 120, a ratio of model weights obtained from the sensor data 116 relative to model weights obtain from the known data 202. The model adaptation 302 can be performed iteratively over time such that the model weights can be adapted over time and/or device operations.

In some implementations, the model adaptation 302 can be performed over time and/or number of operations of the device 104. For example, in time-based scenarios, the model adaptation 302 can be performed by using a hyperparameter to progressively increase a weight value for the sensor data 116 and decrease a weight value for the known data set 202 over time. Alternatively, the model adaptation 302 can be performed to progressively decrease a weight value for the sensor data 116 and increase a weight value for the known data set 202 over time In operation-based scenarios, the model adaptation 302 can be performed to progressively increase a weight value for the sensor data 116 and decrease a weight value for the known data set 202 as a number of operations (e.g., total accumulated operations) of the device 104 increases. Alternatively, the model adaptation 302 can be performed to progressively decrease a weight value for the sensor data 116 and increase a weight value for the known data set 202 as a number of operations of the device 104 increase. The system 300 can thus be operable over time and/or number of device operations to dynamically adapt operation of the state models 120, e.g., to implement hyperparameters to dynamically modify the second model weights 304 over time and/or number of device operations. The model adaptation can enable optimization (e.g., maximization) of output (e.g., prediction) of the state models 120.

Further to the system 300, the state models 120 can utilize the second model weights 304 to output second present state data 306 and/or second predicted state data 308. The second present state data 306, for example, can represent a present operational state of the device 104, such as a state of different device components 118 of the device 104. The second predicted state data 308 can represent different estimated operational states of the device 104, such as estimated operational states over a future period of time and/or a future number of device operations. In some examples, the second predicted state data 308 can indicate a predicted operational lifetime of the device 104, e.g., a predicted period of time and/or number of operations until the device 104 exceeds threshold acceptable operational parameters.

In some implementations, the first predicted state data 212 and the second predicted state data 308 can indicate different predicted operational lifetimes of the device 104. For example, as sensor data 116 is received over time and/or number of device operations, model weights of the state models 120 can be dynamically adjusted (e.g., modified) to provide predicted state data for the device 104 that is adaptable to changes in operating conditions and/or operating state of the device 104.

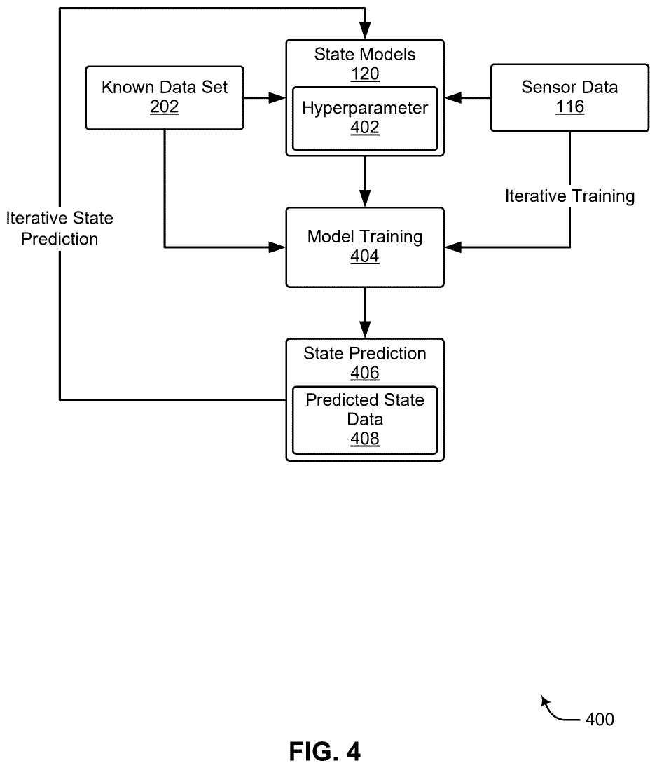

FIG. 4 illustrates an example system 400 in accordance with aspects of the present disclosure. The system 400, for example, describes details for training and implementing state models 120 for predicting state information for devices 104, such as based on the systems 200, 300. In the system 400, the state models 120 can be represented as:

y_{model(x)}=f(x, w)
where:
y represents an attribute (e.g., state attribute) of a device 104 to be monitored;
f represents a state model 120;
x represents an independent variable (e.g., number of device cycles, number of device operations, device operation time, etc.);
w represents weights of a state model 120.

The state models 120 can be operated and/or controlled based on a hyperparameter 402, which represents a variable that can be determined and adjusted over time and/or device operations. In an example, the hyperparameter 402 represents a Bayesian hyperparameter in the form:

μ(x)=g(x,γ)
where:
μ represents the Bayesian hyperparameter;
g represents a function for decreasing a value of the hyperparameter 402 (μ);
γ represents parameters of the function g, which may be used to decrease and/or modify μ using x.

As part of training the state models 120, the system 400 can perform model training 404 using the known data 202 and the sensor data 116. In implementations, the model training 404 may include calculating (e.g., minimizing) a cost function based on the known data 202 and the sensor data 116. In implementations, the cost function f_{c} can take the form:

f_{c}=k(y_{data}(x), f(x, w_{sensordata}))+μ(x)h(w_{sensordata}, w_{knowndata}, s_{knowndata})
where:
w_{sensordata} represents weights of the sensor data 116 applied for the state models 120;
w_{knowndata} represents weights of the known data 202 applied for the state models 120;
s_{knowndata} represents a distribution and/or range of values for w_{knowndata}; and
k represents the likelihood function between the attribute of a device 104 to monitor and the state model 120

In implementations, the model training 404 can be performed iteratively over time using the sensor data 116 (and optionally the known data set 202) to iteratively calculate (e.g., minimize) the cost function f_{c} to perform state prediction 406 (e.g., state inference, model inference) for a device 104. In implementations, the state prediction 406 can include determining predicted state data 408 (\hat{x}) for different estimated device states, e.g., [symbol] , [symbol] , . . . [symbol] . The state prediction 406 may include determining different state information, such as the present state data 210 and/or the predicted state data 212.

Alternatively, or in addition, the model training 404 using the sensor data 116 (and optionally the known data set 202) can be performed iteratively to calculate (e.g., minimize) the cost function and perform the state prediction 406 of the predicted state data 408 as additional sensor data 116 is received over time and/or number of device operations. As the model training 404 may occur dynamically, the hyperparameter 402 can be adapted based on an amount of sensor data 116 that is received. For example, as more sensor data 116 is received, the hyperparameter 402 may place a higher emphasis on the sensor data 116 (e.g., w_{sensordata}) than on the known data 202 (e.g., w_{knowndata}). Further, the state models 120 can be implemented to perform iterative state prediction over time and/or device operations, such as based on iterative model training of the state models 120.

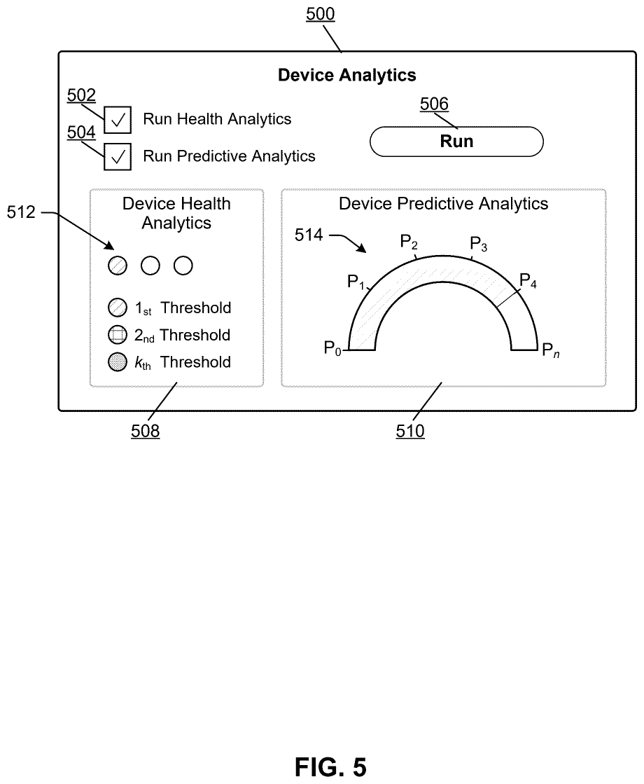

FIG. 5 illustrates an example GUI 500 in accordance with aspects of the present disclosure. The GUI 500, for example, represents an instance of the GUIs 128 and can be generated and/or output (e.g., by the interface module 122) to indicate different state information for a device, e.g., the device 104. The GUI 500 includes analytics options including a health analytics option 502 and a predictive analytics option 504. The health analytics option 502 is selectable to enable present state data of a device to be presented, e.g., the present state data 124 for the device 104. The predictive analytics option 504 is selectable to enable predictive state data of a device to be presented, e.g., the predicted state data 126 for the device 104. A run control 506 is selectable to run different analytics, e.g., for the health analytics option 502 and/or the predictive analytics option 504.

The GUI 500 also includes a health analytics region 508 and a predictive analytics region 510. The health analytics region 508 may be configured to output (e.g., display) present state data for a device. For example, the health analytics region 508 can output present state data 124 for the device 104. The health analytics region 508 includes a health analytics indicator 512 that indicates a present operational condition of a device. The health analytics indicator 512, for example, can indicate a present operation condition of a device from multiple different operational condition thresholds. The different operational condition thresholds can include a 1^{st} threshold (e.g., a device is operating within an optimal operating state), a 2^{nd} threshold (e.g., a device is progressing beyond an optimal operating state), and a kth threshold, e.g., a device is nearing an end of a functional operating state.

The predictive analytics region 510 may be configured to output (e.g., display) predicted state data for a device. For example, the predictive analytics region 510 can output predicted state data 126 for the device 104. The predictive analytics region 510 includes a predicted health indicator 514 that indicates predicted operational conditions of a device over time and/or number of operations. For example, the predicted health indicator 514 indicates health units of P, which can represent time units (e.g., months, weeks, days, etc.), operational units (e.g., number of device operations), or a combination of both. In some examples, a health value Pₙ represents a maximum predicted operational lifespan of a device, e.g., in units of time and/or device operations. Further, the health values P₄, P₃, . . . P₀ may represent descending estimated operational lifetime values (e.g., in time units, operational units) of the device, with P₀ representing an estimated end of an operational lifetime of the device. In the example GUI 500, the predicted health indicator 514 may indicate that a device is predicted to be at a health value of P₄, where P₄ may indicate an estimated remaining operational time and/or estimated number of remaining operations of a device.

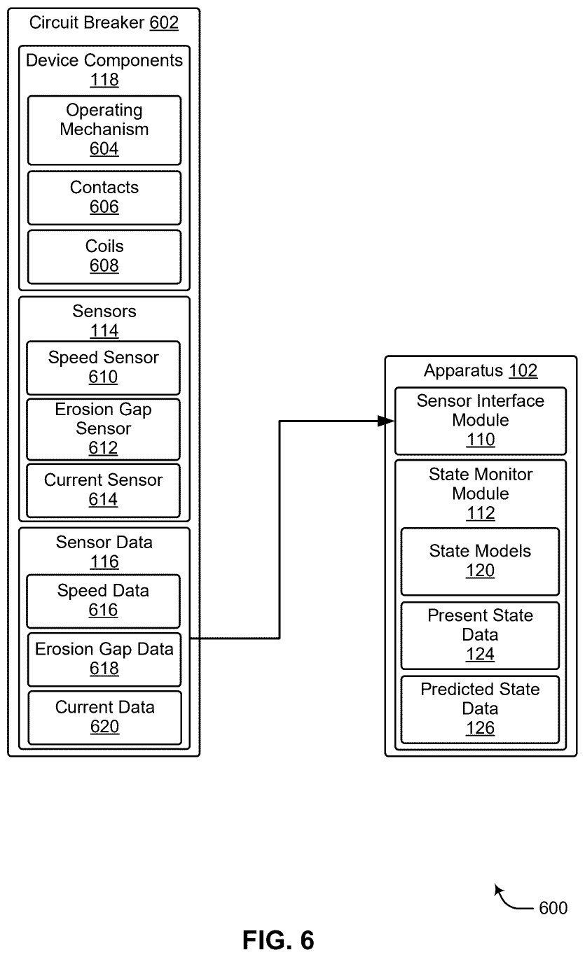

FIG. 6 illustrates a system 600 for AI for device life cycle prediction in accordance with aspects of the present disclosure. The system 600 depicts an implementation applied to a circuit breaker 602, which may represent an instance of the device 104. The circuit breaker 602, for example, represents a device (e.g., hardware device) that is operable to automatically interrupt the flow of electricity in a circuit when an overload, short circuit, or other electrical fault occurs. The circuit breaker 602 includes device components 118 and sensors 114. The device components 118 of the circuit breaker 602 include an operating mechanism 604, contacts 606, and coils 608. The operating mechanism 604 may represent a mechanical mechanism that is operable to open and close the contacts 606, such as to enable and disable electrical current flow through the circuit breaker 602. The contacts 606 may represent conductive elements that enable electrical current flow when the circuit breaker 602 is in a closed position. The coils 608 may represent components through which electrical current flows to control operation of the circuit breaker, such as to trigger opening and closing the operating mechanism 604 and to enable and disable flow of electrical current through the circuit breaker 602.

The sensors 114 of the circuit breaker 602 include a speed sensor 610, an erosion gap sensor 612, and a current sensor 614. The speed sensor 610 may operate to detect a speed at which different components of the circuit breaker 602 operate, such as opening and closing speeds of the operating mechanism 604 and/or the contacts 606. The erosion gap sensor 612 may operate to measure an erosion gap between the contacts 606, such as a gap between the contacts 606 when the contacts 606 are closed. The current sensor 614 may operate to detect an electrical current through the coils 608.

The sensors 114 of the circuit breaker 602 may generate sensor data 116, including speed data 616, erosion gap data 618, and current data 620. The speed data 616 may represent data generated via the speed sensor 610 that indicates a speed (e.g., velocity) at which the operating mechanism 604 and/or the contacts 606 move between open and closed positions, and vice-versa. The erosion gap data 618 may represent data generated via the erosion gap sensor 612 that indicates an erosion gap between the contacts 606. With reference to the systems 200-400, the erosion gap data 618 may represent y, e.g., a state attribute of the circuit breaker 602 to be monitored for life cycle prediction. The current data 620 may represent data generated via the current sensor 614 that indicates an electrical current (e.g., in amperes) that flows through the coils 608.

Further to the system 600, the sensor data 116 can be communicated to the sensor interface module 110 of the apparatus 102, and the state monitor module 112 can utilize the sensor data 116 to determine state data for the circuit breaker 602. For example, and as described throughout this disclosure, the state monitor module 112 can input the sensor data 116 to the state models 120 to determine present state data 124 and predicted state data 126 for the circuit breaker 602. The present state data 124 may indicate a present operating state of the circuit breaker 602, such as a present operating speed of the operating mechanism 604 and/or the contacts 606. The present state data 124 may indicate a present erosion gap between the contacts 606, and a current flow through the coils 608.

The predicted state data 126 for the circuit breaker 602 may indicate an estimated operational lifetime of the circuit breaker 602, such as indicated in time units and/or number of operations. For example, the predicted state data 126 may indicate a duration of time and/or a number of device operations over which the circuit breaker 602 is estimated to be operable within one or more threshold operation parameters.

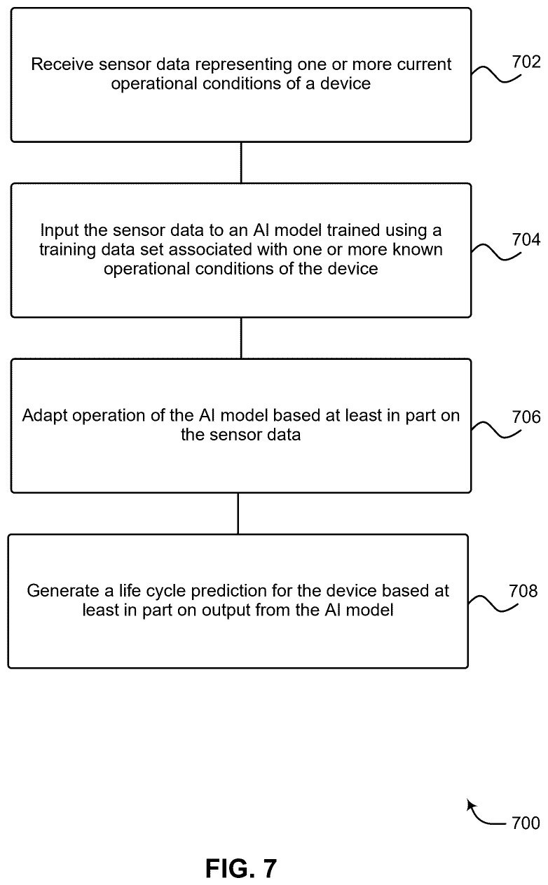

FIG. 7 illustrates a flow chart depicting an example method 700 for AI for device life cycle prediction in accordance with one or more implementations. At 702, sensor data representing one or more present operational conditions of a device is received. The sensor interface module 110 of the apparatus 102, for example, can receive present (e.g., current, real-time, near real-time) sensor data from sensors 114 of the device 104. Examples of the present sensor data are described throughout this disclosure, and include motion data, power data (e.g., power current data, voltage data), contact distance data (e.g., gap data), temperature data, etc.

At 704, the sensor data is input to an AI model trained using a known data set associated with one or more known operational conditions of the device. For instance, the state monitor module 112 inputs the sensor data into a state model 120. The state model 120, for example, is previously trained using a known data set 202.

At 706, operation of the AI model is adapted based at least in part on the sensor data. For example, operational parameters of the state model 120 (e.g., a hyperparameter) are modified based on the sensor data. In some implementations, a hyperparameter modifies one or more weights of the state model 120 by adjusting a ratio of the sensor data relative to the known data set. For instance, the ratio of the sensor data relative to the known data set is adjusted by increasing a weight value for the sensor data and decreasing a weight value for the known data set. Alternatively, the ratio of the sensor data relative to the known data set can be adjusted by decreasing a weight value for the sensor data and increasing a weight value for the known data set. In some implementations, the ratio of the sensor data relative to the known data set is adjusted based at least in part on one or more of a time period over which the sensor data is received, or an amount of the sensor data that is received.

At 708, a life cycle prediction for the device is generated based at least in part on output from the AI model. For example, the life cycle prediction is based at least in part on a comparison of the output from a state model 120 to one or more life cycle thresholds. The life cycle thresholds can be specified and/or defined based on known and/or predicted life cycle attributes of the device.

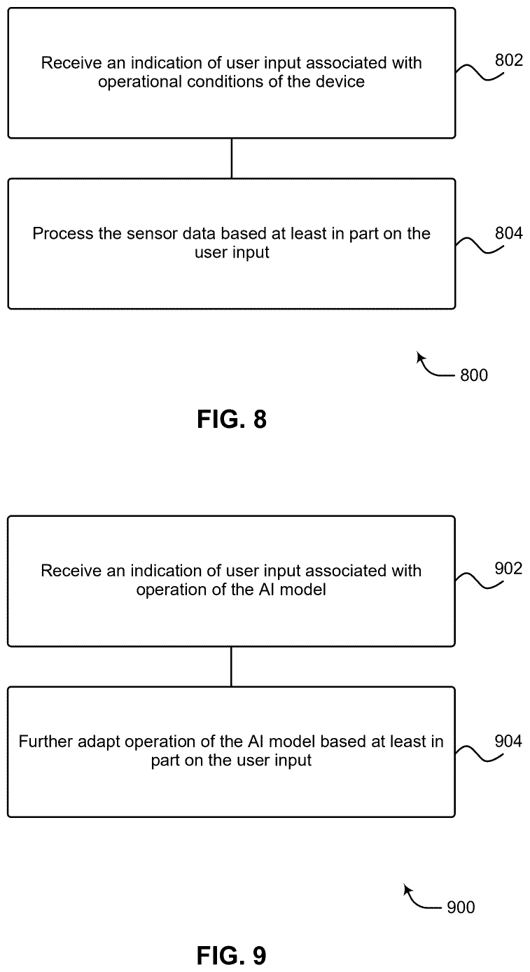

FIG. 8 illustrates a flow chart depicting an example method 800 for AI for device life cycle prediction in accordance with one or more implementations. At 802, an indication is received of user input associated with operational conditions of the device. The interface module 122, for example, receives user input to a GUI 128 to specify one or more operational conditions of a device 104. For instance, the specified operational conditions can include various parameters such as temperature values, electrical current values, gap values (e.g., erosion gap values), humidity values, etc. At 804, the sensor data is processed based at least in part on the user input. For instance, the state monitor module 112 can adjust and/or modify received sensor data based on the user input. The adjusted and/or modified sensor data may be used as input to the state models 120, such as for enabling the state models 120 to output the present state data 124 and/or the predicted state data 126.

FIG. 9 illustrates a flow chart depicting an example method 900 for AI for device life cycle prediction in accordance with one or more implementations. At 902, an indication is received of user input associated with operation of the AI model. The state monitor module 112, for example, can receive user input to modify one or more operational parameters of the state models 120. In some implementations, the user input may include modification of a hyperparameter associated with the AI model. At 904, operation of the AI model is further adapted based at least in part on the user input. For instance, model weights of the state models 120 can be modified based on the user input.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 10 illustrates various components of an example apparatus 1000 in which aspects of AI for device life cycle prediction can be implemented. The example apparatus 1000 can be implemented as any of the devices described with reference to the previous FIGS. 1-9, such as any type of client device, mobile device, computing device, communication device, and/or other type of electronic device. For example, the apparatus 102 as described with reference to FIGS. 1-8 may be implemented as the example apparatus 1000.

The apparatus 1000 includes communication transceivers 1002 that enable wired and/or wireless communication of device data 1004 with other devices. The device data 1004 can include sensor data, device identifying data, device location data, wireless connectivity data, and wireless protocol data. Additionally, the device data 1004 can include any type of audio, video, and/or image data. Example communication transceivers 1002 include radios compliant with IEEE 802.15 (Bluetooth™) standards, wireless local area network (WLAN) radios compliant with IEEE 802.11 (Wi-Fi™) standards, wireless wide area network (WWAN) radios for wireless cellular communication, wireless metropolitan area network (WMAN) radios compliant with IEEE 802.16 (WiMAX™) standards, wired local area network (LAN) Ethernet transceivers for network data communication, etc.

The apparatus 1000 may also include one or more data input ports 1006 via which different types of data, media content, and/or inputs can be received. The data input ports 1006 may include wireless ports, USB ports, coaxial cable ports, and other serial or parallel connectors (including internal connectors) for flash memory, and the like. The data input ports 1006 may be used to couple the device to any type of components, peripherals, or accessories.

The apparatus 1000 includes a processor system 1008 of one or more processors (e.g., any of microprocessors, controllers, and the like) and/or a processor and memory system implemented as a system-on-chip (SoC) that processes computer-executable instructions. The processor system 1008 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the apparatus 1000 can be implemented with any one or combination of software, hardware, firmware, or logic circuitry that is implemented in connection with processing and control circuits, which are identified at 1010. The apparatus 1000 may further include any type of a system bus or other data and command transfer system that couples the various components within the apparatus 1000.

The apparatus 1000 also includes memory devices 1012 that enable data storage, such as data storage devices that can be accessed by a computing device, and that provide persistent storage of data and executable instructions (e.g., software applications, programs, functions, and the like). Examples of the memory devices 1012 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations.

The memory devices 1012 provide data storage mechanisms to store the device data 1004, other types of information and/or data, and various device applications 1014 (e.g., software applications). For example, an operating system 1016 can be maintained as software instructions via a memory device 1012 and executed by the processor system 1008. The memory devices 1012 represent media and/or devices that enable persistent and/or non-transitory storage of information in contrast to mere signal transmission, carrier waves, or signals per se. The memory devices 1012 do not include signals per se or transitory signals.

In this example, the apparatus 1000 includes a sensor interface module 1018 and state monitor module 1020 that can implement aspects of AI for device life cycle prediction, and which may be implemented with hardware components and/or in software. For example, sensor interface module 1018 can be implemented as the sensor interface module 110, and the state monitor module 1020 can be implemented as the state monitor module 112, described in detail above.

In this example, the example apparatus 1000 also includes a camera 1022 and motion sensors 1024. The motion sensors 1024 can be implemented with various sensors, such as a gyroscope, an accelerometer, and/or other types of motion sensors to sense motion of the device. The apparatus 1000 may also include a wireless module 1026, which is representative of functionality to perform various wireless communication tasks. The apparatus 1000 may also include one or more power sources 1028, such as wired and/or battery-based power sources.

The apparatus 1000 also includes an audio and/or video processing system 1030 that generates audio data for an audio system 1032 and/or generates display data for a display system 1034. The audio system 1032 and/or the display system 1034 may include devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as a media data port 1036. In implementations, the audio system 1032 and/or the display system 1034 represent integrated components of the apparatus 1000.

Although implementations of AI for device life cycle prediction are described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples.

1. An apparatus, comprising:
at least one memory; and
at least one processor coupled with the at least one memory and operable to cause the apparatus to:
receive sensor data representing one or more present operational conditions of a device;
input the sensor data to an artificial intelligence (AI) model trained using a known data set associated with one or more known operational conditions of the device;
adapt operation of the AI model based at least in part on the sensor data; and
generate a life cycle prediction for the device based at least in part on output from the AI model.

2. The apparatus of claim 1, wherein the sensor data comprises one or more of motion data, power data, contact distance data, temperature data, or image data.

3. The apparatus of claim 1, wherein the AI model is trained using the known data set prior to input of the sensor data to the AI model.

4. The apparatus of claim 1, wherein the operation of the AI model is adapted via modification of a hyperparameter associated with the AI model based at least in part on the known data set and the sensor data.

5. The apparatus of claim 4, wherein modification of the hyperparameter comprises adjusting a ratio of the sensor data relative to the known data set.

6. The apparatus of claim 5, wherein adjusting the ratio of the sensor data relative to the known data set comprises one of:
increasing a weight value for the sensor data and decreasing a weight value for the known data set; or
decreasing a weight value for the sensor data and increasing a weight value for the known data set.

7. The apparatus of claim 5, wherein adjusting the ratio of the sensor data relative to the known data set is based at least in part on one or more of a time period over which the sensor data is received, or an amount of the sensor data that is received.

8. The apparatus of claim 1, wherein the life cycle prediction is based at least in part on a comparison of the output from the AI model to one or more life cycle thresholds.

9. The apparatus of claim 1, wherein the at least one processor is operable to cause the apparatus to:
output an indication of the life cycle prediction, wherein the indication of the life cycle prediction comprises an indication of a duration over which the device is estimated to be operable within one or more threshold operation parameters.

10. The apparatus of claim 9, wherein the indication of the duration comprises one or more of a time duration or a number of operations of the device.

11. The apparatus of claim 10, wherein the indication of the duration comprises a first indication of a duration of an operational lifetime of the device, and a second indication of an operational extension of the duration of the operational lifetime of the device.

12. The apparatus of claim 1, wherein the at least one processor is operable to cause the apparatus to:
receive an indication of user input associated with operational conditions of the device; and
process the sensor data based at least in part on the user input.

13. The apparatus of claim 1, wherein the at least one processor is operable to cause the apparatus to:
receive an indication of user input associated with operation of the AI model; and
further adapt operation of the AI model based at least in part on the user input.

14. The apparatus of claim 13, wherein the user input comprises a modification of a hyperparameter associated with the AI model.

15. The apparatus of claim 1, wherein the device comprises a circuit breaker, and wherein the life cycle prediction comprises one or more of an estimated number of remaining operations of the circuit breaker or an estimated remaining operation lifetime of the circuit breaker.

16. The apparatus of claim 15, wherein the sensor data and the one or more known operational conditions of the circuit breaker are associated with an erosion gap for a set of contacts of the circuit breaker.

17. A method performed by an apparatus, the method comprising:
receiving sensor data representing one or more present operational conditions of a device;
inputting the sensor data to an artificial intelligence (AI) model trained using a known data set associated with one or more known operational conditions of the device;
adapting operation of the AI model based at least in part on the sensor data; and
generating a life cycle prediction for the device based at least in part on output from the AI model.

18. The method of claim 17, wherein adapting operation of the AI model comprises modifying a hyperparameter associated with the AI model based at least in part on the sensor data, and modifying the hyperparameter comprises adjusting a ratio of the sensor data relative to the known data set.

19. The method of claim 18, wherein adjusting the ratio of the sensor data relative to the known data set comprises one of:
increasing a weight value for the sensor data and decreasing a weight value for the known data set; or
decreasing a weight value for the sensor data and increasing a weight value for the known data set.

20. A system, comprising:
a sensor interface operable to receive sensor data representing one or more present operational conditions of a device; and
a state monitor operable to:
input the sensor data to an artificial intelligence (AI) model trained using a known data set associated with one or more known operational conditions of the device;
adapt operation of the AI model based at least in part on the sensor data; and
generate a life cycle prediction for the device based at least in part on output from the AI model.
